(19) United States
(12) Patent Application Publication
(10) Pub. No.: US 2026/0346284 A1
(43) Pub. Date: Nov. 5, 2026

(54) Reuseable Dispenser for Consumable Product Container

(71) Applicant: Boban Jose, Danville, CA (US)

(72) Inventor: Boban Jose, Danville, CA (US)

(21) Appl. No.: 19/198,096

(22) Filed: May 4, 2025

(51) Int. Cl. B05B 11/10; B05B 11/00

(52) U.S. Cl. CPC B05B 11/1047; B05B 11/0038

(57) ABSTRACT

A device may include a dispenser body including a first end, second end and a sidewall extending therebetween, the sidewall defining the dispenser body as tubular with a chamber therein. The device may include a pump connected to the first end of the dispenser body. The dispenser body may include an opening at the second end, the opening defined by the sidewall, and the opening configured to receive the container into the chamber. A resting surface may be within the chamber and connected to the sidewall. The resting surface being configured to engage a top portion of the container. A securing mechanism may be adjacent the opening at the second end, and the securing mechanism may be configured to exert upward force on the container within the chamber.

### BACKGROUND OF THE DISCLOSURE

### 1. Field of the Disclosure

This disclosure relates to dispensing systems for consumable products. More specifically, a dispenser reusable with different can such as brite cans is disclosed.

### 2. Background of the Related Art

Dispensing personal care and household consumables traditionally relies on rigid plastic packaging and integrated pumps, which are typically discarded after use. This widespread practice contributes to plastic waste and resource inefficiency. While refill pouch solutions exist, they often require manual transfer of the product, which can be messy, wasteful, and unhygienic.

There remains a need for a dispenser system that allows direct use of a refillable container as the product reservoir, without the need for content transfer. Brite cans, commonly used in the beverage industry, offer a cost-effective, recyclable container format but lack compatibility with traditional pump dispensers.

Therefore, there is a need to advance sustainability goals with a reusable dispenser system that accommodates such brite cans, provides a leak-proof interface, and enables easy interchange of refills.

### SUMMARY OF THE DISCLOSURE

The present disclosure provides a reusable dispensing system designed to interface directly with refillable, standardized containers such as brite cans. The dispensing system may include the following. A dispenser body with a pump assembly at the top and an open bottom for container insertion. An internal resting surface, optionally fitted with a gasket, provides create a leak-resistant junction with the container's rim. A securing mechanism, actuated by an external slidable clamp, that engages the bottom of the container and applies upward pressure to maintain contact between the resting surface and an upper surface or rim of the container to hold the container in place and may create an environmental seal. A flexible or offset-aligned intake tube designed to reach the container's opening even when it is not centered. The system simplifies the consumer's experience by eliminating product transfers and reducing environmental waste, as only the refill container is replaced. Further, the system enables hygienic, leak-free dispensing and promotes sustainability through the reuse of recyclable packaging formats.

In some aspects, the techniques described herein relate to a dispenser system for a container including: a dispenser body including a first end, second end and a sidewall extending therebetween, the sidewall defining the dispenser body as tubular with a chamber therein; a pump connected to the first end of the dispenser body; an opening at the second end, the opening defined by the sidewall, the opening configured to receive the container into the chamber; a resting surface within the chamber and connected to the sidewall, the resting surface extending from the sidewall into the chamber, the resting surface configured to engage a top portion of the container; and a securing mechanism adjacent the opening at the second end, the securing mechanism configured to exert upward force on the container within the chamber.

In some aspects, the techniques described herein relate to a system, wherein the securing mechanism further includes: at least one tab connected to the sidewall, the tab moveable from a secured position extending into the chamber and a released position removed from the chamber, wherein the tab in the released position allows upward movement of the container into the chamber and the tab, in the secured position, prevents downward movement of the container.

In some aspects, the techniques described herein relate to a system wherein the at least one tab is a spring-loaded tab.

In some aspects, the techniques described herein relate to a system, wherein the securing mechanism further includes: at least tab connected to the sidewall; and an activation mechanism moveable on the dispenser body and configured to actuate the at least one tab between a secured position and a released position.

In some aspects, the techniques described herein relate to a system, wherein the securing mechanism further includes: at least one tab connected to the sidewall, the at least one tab moveable from a secured position extending into the chamber and a released position removed from the chamber; and a clamp on an exterior of the dispenser body, the clamp configured to actuate the at least tab between a secured position and a released position, wherein the clamp is configured to force the at least one tab into the chamber in the secured position and in the released position, the clamp places the at least tab into the released position.

In some aspects, the techniques described herein relate to a system, wherein a gasket is connected to the resting surface and the gasket is configured to abut a portion of the container to prevent leakage.

In some aspects, the techniques described herein relate to a system, wherein the container includes a brite can containing a consumable liquid.

In some aspects, the techniques described herein relate to a system, further including: an intake tube connected to the pump and extending into the chamber.

In some aspects, the techniques described herein relate to a system, wherein the dispenser is configured to receive a container through the opening, engage the container with resting surface, and is secured by the securing mechanism.

In some aspects, the techniques described herein relate to a dispenser system for a container including: a dispenser body including a first end, second end and a sidewall extending therebetween, the sidewall defining the dispenser body as tubular with a chamber therein; a pump connected to the first end of the dispenser body; an opening at the second end, the opening defined by the sidewall, the opening configured to receive the container into the chamber; a resting surface within the chamber and connected to the sidewall, the resting surface extending from the sidewall into the chamber, the resting surface configured to engage a top portion of the container; and at least one tab connected to the sidewall, the tab moveable from a secured position extending into the chamber and a released position removed from the chamber, wherein the tab in the released position allows upward movement of the container into the chamber and the tab, in the secured position, prevents downward movement of the container.

In some aspects, the techniques described herein relate to a system, further including: a clamp on an exterior of the dispenser body, the clamp configured to actuate the at least tab between a secured position and a released position, wherein the clamp is configured to force the at least one tab into the chamber in the secured position and in the released position, the clamp places the at least one tab into the released position.

In some aspects, the techniques described herein relate to a system, wherein the at least one tab is a spring-loaded tab.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a perspective view of an embodiment of a reusable dispenser according to this disclosure, and a product container for use therein, with the container positioned outside of the dispenser;

FIG. 2 is a perspective view of the reusable dispenser of FIG. 1 with the product container inserted and secured within the dispenser; and

FIG. 3 is a flow diagram of a method, according to this disclosure, of making the reusable dispenser of FIG. 1.

### DETAILED DESCRIPTION OF THE DISCLOSURE

Certain terminology is used in the following description for convenience only and is not limiting. As used herein, the word “connected” is intended to include integrally formed members, direct connections between two distinct members without any other members interposed therebetween and indirect connections between members in which one or more other members are interposed therebetween. The terminology includes the words specifically mentioned above, derivatives thereof, and words of similar import.

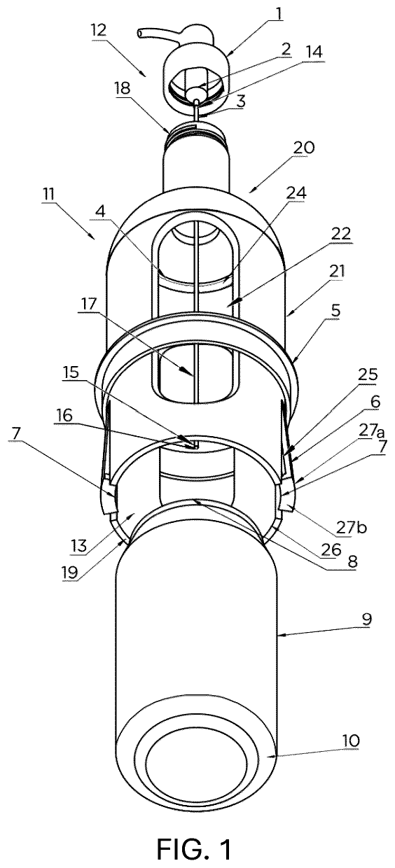

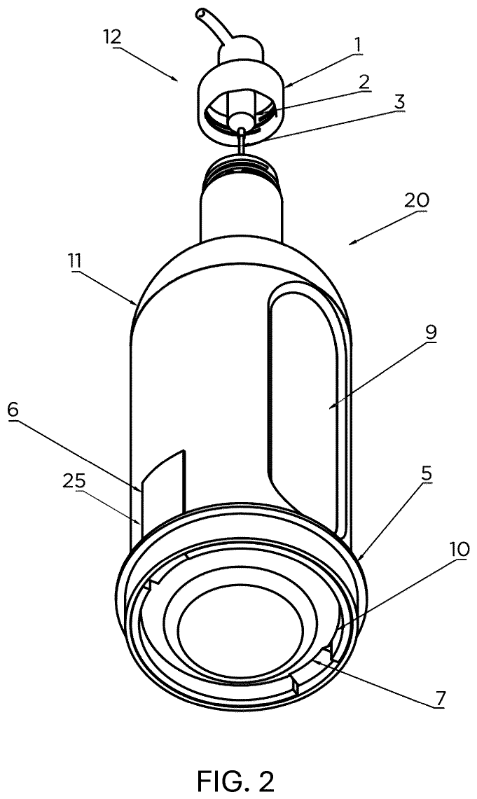

Referring now to the drawings in detail, wherein like numbers are used to indicate like elements throughout, FIGS. 1-2 depict a preferred embodiment of a reusable dispenser 20 including a liquid pump assembly 1 within pump housing 12, and dispenser body 11 with internal support or resting surface 4 and chamber 13, securing mechanism 6 including retaining clamp 5, and notches 7. As shown in FIG. 1, dispenser 20 allows product container 9 to be inserted into dispenser body 11 and connected to pump assembly 1 for use. As shown in FIG. 2, product container 9 may be removed from the dispenser body 11 and replaced with a fresh or different product can as desired.

Pump assembly 1 is positioned in pump housing 12, and assembly 1 may include pump 2 and intake tube 3 to draw product from container 9. Pump 2 may include a manual or spring-return dispensing pump with a press-down actuator for withdrawing product from container 9. Pump 2 may be selected based on the viscosity of the product and may include one-way valves to prevent air ingress and/or variable stroke volume for different product types.

As shown in FIGS. 1-2, tube 3 is a generally vertical intake for tube 3 extending into the internal chamber 13. Tube 3 includes a first end 14 connected to assembly 1 and a second end 15 with opening 16 and body 17 extending therebetween. Second end 15 extends into chamber 13 for insertion into container 9. Although FIG. 1 depicts tube 3 as substantially straight or vertical, in the preferred embodiment, tube 3 is preferably made of a food or cosmetic grade material such as a plastic and/or silicon, etc. such that tube 3 may include body 17 with at least a portion thereof flexible enough to reach offset openings in container 9 typical in brite cans. Additionally, tube 3 may be pre-set with a curved body 17 configuration to adapt to the position of offset opening in containers 9. Also, it is preferred that tube 3 be dimensioned to reach near the bottom of the container to minimize residual product.

Chamber 13 is tubular and may include first chamber end 18, second chamber end 19 and chamber sidewall 21 extending therebetween. Sidewall 21 defines chamber 13 which may be entirely hollow with internal space extending from end 18 to end 19. End 18 may connect to pump housing 12 while end 19 remains open to allow bottom-up insertion of a pre-filled container 9. The connection of housing 12 with end 19 may be through threaded fasteners, clips or press fit, etc. Suitable containers include aluminum brite cans or equivalent vessels with a top opening formed by pull-tab removal, threaded connector and/or pre-scored seals, etc.

Internal support or resting surface 4 extends into chamber 13 from internal surface 22 of sidewall 21 and renders the internal width or diameter of chamber 13 smaller across surface 4 than across sidewall 21. As shown in FIG. 1, surface 4 is directly connected to and abuts surface 22 and may extend substantially horizontally into chamber 13 from surface 22. Internal support of resting surface 4 may assist in securing can 9 in place within chamber 13. That is, surface 4 provides a contact surface for upper portion and/or container rim 8 to abut dispenser 20 allowing dispenser 20 to rest on surface 4. Also, the contact between container 9 and surface 4 assists in holding container 9 in place as well as providing a seal between the liquid in container 9 and the environment.

Resting surface 4 may also include a replaceable or fixed gasket 24 at least on a lower surface of surface 4. Gasket 24 may be made of a range of materials such as silicone, rubber, any/or thermoplastic elastomer, etc. Therefore, when product can 9 is inserted into chamber 9, surface 4 and when provided gasket 24 abut upper rim or surface 8 of can 9 and may provide an air-tight seal between dispenser 20 and can 9. Further, resting surface 4 may include a chamfered or recessed groove to aid alignment and sealing.

Securing mechanism 6 may include clamp 5, one or more notches 25 and one or more corresponding tabs 7 formed in sidewall 21 as well as clamp 5 external to sidewall 21. As shown in FIGS. 1 and 2, tabs 7 may be located at end 19 and may include a portion of sidewall 21 spaced apart by notches 25 which extend from end 19 into sidewall 21. Due to the elasticity of the material of sidewall 21, the one or more notches 25 form one or more moveable tabs 7 that may be spring-loaded. Further, tabs 7 are located near the bottom opening 26 defined by sidewall 21 and end 19. It is noted that securing mechanism 6 may also be referred to as a locking mechanism.

As shown in FIGS. 1-2, the one or more tabs 7 may include a sidewall portion 27a connected to a tab portion 27b extending at an angle to sidewall portion 27a. Sidewall portion 27a is formed of the sidewall 21 but spaced apart from sidewall 21 by one or more notches 25. As a result, sidewall portion 27a may have same or similar angle of curvature of sidewall 21. On the other hand, tap portion 27b extends into chamber 13 from sidewall 21 such that tab portion(s) 27b may abut a base 10 of can 9 and hold can 9 in place within chamber 13. For example, tab portions 27b may secure can 9 in chamber 13 such that rim 8 of can 9 remains sealed against surface 22 and/or gasket 24. Therefore, one or tabs 7 and notches 25 hold container 9 in place and assist with maintaining the seal between dispenser 20 and container 9.

The one or more moveable tabs 7 may be formed through different methods. For example, tabs 7 as shown in the preferred embodiment of FIGS. 1-2 are spring loaded, but this could also be a hinged configuration with tabs 7 being connected to sidewall 21 with a swivel hinge or any other type of pivoting hinge that allows tabs 7 moveable with respect to sidewall 21. That is, any connection of tab portion 27a to sidewall 21 may be used that allows for the movement of tab portion 27a towards sidewall 21 and away from sidewall 21.

Clamp 5 is located external to sidewall 21 and chamber 13. Also, clamp 5 is moveable from a lock position at end 19 to a release position above one or more tabs 7 and/or notches 25. As shown in FIGS. 1 and 2 clamp 5 is circular or disc shaped and extends entirely around the circumference of chamber 13. Further, clamp 5 may conveniently slide up and down sidewall 21. Clamp 5 aids one or tabs 7 in holding container 9 in a vertical and sealed position in chamber 9. These are actuated by an external retaining clamp that slides vertically along the dispenser's outer shell. In the “release” position, the notches retract from chamber 13, allowing the container 9 to be inserted. In the “secured” or “locked” position, clamp 5 presses the notches inward, causing them to exert lateral and/or upward force against the container's base 10. Thus, clamp 5 in conjunction with tabs 27 ensures consistent contact with the upper sealing surface, prevents leakage, and stabilizes container 9 during use.

For ease of use, retaining clamp 5 may include tactile indicators or detents to signal locked/unlocked states. Although clamp 5 is depicted in this embodiment as a ring completely surrounding sidewall 21, other embodiments are contemplated. For example, clamp 5 may be configured with a snap-fit, bayonet, or magnetic locking mechanism as alternatives to spring-loaded notches. Also, clamp 5 may only surround a portion of sidewall 21 sufficient to provide the locking function.

### Use Case Example

A consumer purchases hand lotion in a recyclable brite can 9. Then, the use inserts can 9 into the reusable dispenser 20. Tube 3 enters the offset opening, and the user slides retaining clamp 5 down to engage the securing tabs 27. The lotion is then dispensed via the pump 2 without any need for pouring or product transfer. Once empty, can 9 is removed and replaced with a new one. That is, the user slides clamp 5 up so the spring mechanism of tabs 27 allows tab portions 27b to move outwardly from chamber 13. Thus, the user removes the empty can 9 and can 9 may be recycled.

FIG. 1 depicts dispenser 20 in a first or ready to load a can 9 configuration. Clamp 5 is in the release position above tabs 7 and notches 25 and tabs 7 are extending away external to sidewall 21 such that tap portions 27a do not protrude into opening 19. Container 9 has a shape corresponding to the chape of chamber 13 and may be inserted into the dispenser through 19 opening at the bottom or end 19. During insertion, the intake tube 3 is directed into the container's top opening, allowing tube 9 to be immersed in the product contents within can 9. Top rim 8 of container 9 comes to rest against internal support or resting surface 4, with or without gasket 24, within dispenser 20. This surface may optionally include a sealing gasket to ensure a leak-resistant interface with the container. In this configuration, locking mechanism 6 remains disengaged, as the tabs 7 are not yet compressed or retained by clamp 5, thus allowing unobstructed insertion of the container into the dispenser.

FIG. 2 illustrates dispenser 20 after product container 9 has been fully inserted and secured. In this configuration, retaining clamp 5 is shown in the lowered or locked position. As clamp 5 descends, it applies inward pressure on the flexible locking tabs 7, causing them to deflect inward and press upward against container base 10. This action secures container 9 in place within chamber 13 and forces top rim 8 of container 9 into firm contact with surface 4, thereby creating a sealed and stable assembly.

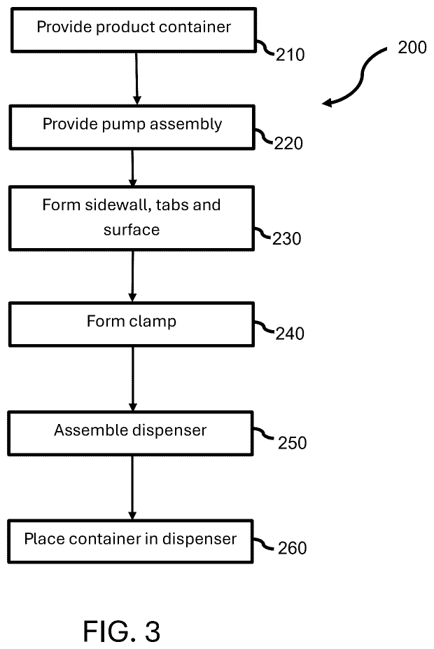

A method 200, according to this disclosure, of making dispenser 20 is provided in FIG. 3. A standard product container 9, such as a brite can, that may be filled with a liquid product to be dispensed is provided in step 210. The liquid product may include liquid soap or condiments, etc. The dimensions, such as height and width, of container 9 as well as the positioning of the opening in the top of container 9 are identified.

Once the dimensions are known, dispenser 20 may be formed to accommodate container 9. As discussed above, pump assembly 1 including pump housing and pump 2 and intake tube 3 are provided in step 220. Preferably, intake tube 3 may be provided with a length suitable to extend from the pump through the height of the container 9. Also, as discussed above, intake tube 3 may include a curve or flexible portion capable of accommodating an offset between the connection of tube 3 to pump 2 and the opening in container 2. If pump housing 12 must be provided as a custom fit to the sidewall 21, then housing 12 may be formed through processes known in the art such as injection molding and additive manufacturing.

In step 230, dispenser body 11 is formed including sidewall 21, resting surface 4 and at least one spring-loaded tab 7 or a plurality of tabs 7, as needed, is formed. Sidewall 21 and may be formed integral with spring-loaded tabs 7 through manufacturing processes such as additive manufacturing or injection molding. The spring-loading of the tabs may be accomplished by producing sidewall 21 with tabs 7 in the released position of FIG. 1. Preferably, surface 4 and tabs 7 are formed integral with sidewall 21 during manufacturing. However, surface 4 and tabs 7 may be formed separately and later connected to sidewall 21. That is, surface 4 may be connected to sidewall 21 through processes such as heat sealing, epoxies and adhesives, etc. Tabs 7 may be connected through hinges or other types of pivots.

The material selected for sidewall 21 and spring-loaded tabs 7 helps ensure tabs 7 are moveable from the released position of FIG. 1 to the secured position of FIG. 2. That is, the material should have enough strength to support pump assembly 1 as well as elasticity and flexibility. Suitable materials include resins, plastics, rubberized materials, polymer. Further, sidewall 21 may be formed of sheet metal which includes various metals and metal alloys.

In the preferred embodiment, sidewall 21 is formed at a height such that product container 9 abuts surface 4 and tab portion 27b at some point on the bottom of container 9. The dimensions of the sidewall 21 may be suitable to at least partially surround container 9 and may include windows for observing the product container. The height of sidewall 21 may be different based on the product container 9 height and base 10 of the product container 9. As shown in FIG. 2, base 10 includes a diagonal edge that tab 7 abuts rather than the lowest surface of container 9. Due to this configuration of container 9, sidewall 21 may be coplanar with the bottom of container 9. When used with other type of container 9, the sidewall 21 may need to extend below the bottom of the container 9 for the best contact between tabs 7 and the dispenser 20.

Sidewall 21 may also be formed such that it defines first chamber end 18. That is, sidewall 21 may include a suitable connection to the pump assembly 1. The connection may include a threaded fastener or a press fit.

Additionally, gasket 24 may be applied to resting surface 24. As discussed above, gasket 24 may further assist with an air-tight and leak proof seal between dispenser 20 and container 9. Gasket 24 may be made of a range of materials such as silicone, rubber, any/or thermoplastic elastomer, etc. Further, gasket 24 may be coupled to resting surface 24 through over molding, epoxies and adhesives, etc.

In step 240, clamp 5 may be formed with dimensions preferably suitable for sliding along the exterior surface of sidewall 21. Preferably, camp 5 abuts sidewall 21 at least in the areas of the tabs 7. This configuration will allow clamp 5 to force tabs 7 inwardly such that tap portions 27a are forced into chamber 12 and able to exert force on container 9. Clamp 5 may be made of one of the materials provided above for sidewall 21, and clamp 5 may be made of the same or different materials as sidewall 21. Clamp 5 may be formed through processes such as injection molding, additive manufacturing and metal forming.

In step 250, dispenser 20 is assembled. Clamp 5 is placed over sidewall 21, and pump assembly 1 is connected to first chamber end 18 with tube 3 extending into the chamber.

In step 260, container 9 is placed in opening 16 and clamp 5 is moved to the bottom of sidewall 21 such that clamp 9 is at second chamber end 19 and abutting the distal ends of tab portions 27a.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A dispenser system for a container comprising:
a dispenser body including a first end, second end and a sidewall extending therebetween, the sidewall defining the dispenser body as tubular with a chamber therein;
a pump connected to the first end of the dispenser body;
an opening at the second end, the opening defined by the sidewall, the opening configured to receive the container into the chamber;
a resting surface within the chamber and connected to the sidewall, the resting surface extending from the sidewall into the chamber, the resting surface configured to engage a top portion of the container; and
a securing mechanism adjacent the opening, the securing mechanism at the second end, the securing mechanism configured to exert force on the container within the chamber.

2. The system of claim 1, wherein the securing mechanism further comprises:
at least one tab connected to the sidewall, the tab moveable from a secured position extending into the chamber and a released position removed from the chamber,
wherein the tab in the released position allows upward movement of the container into the chamber and the tab, in the secured position, prevents downward movement of the container.

3. The system of claim 2 wherein the at least one tab is a spring-loaded tab.

4. The system of claim 1, wherein the securing mechanism further comprises:
at least one tab connected to the sidewall; and
an activation mechanism moveable on the dispenser body, the activation mechanism configured to actuate the at least one tab between a secured position and a released position.

5. The system of claim 1, wherein the securing mechanism further comprises:
at least one tab connected to the sidewall, the at least one tab moveable from a secured position extending into the chamber and a released position removed from the chamber; and
a clamp on an exterior of the dispenser body, the clamp configured to actuate the at least tab between a secured position and a released position,
wherein the clamp is configured to force the at least one tab into the chamber in the secured position and in the released position, the clamp places the at least tab into the released position.

6. The system of claim 1, wherein a gasket is connected to the resting surface and the gasket is configured to abut a portion of the container to prevent leakage.

7. The system of claim 1, wherein the container comprises a brite can containing a consumable liquid.

8. The system of claim 1, further comprising:
an intake tube connected to the pump and extending into the chamber.

9. The system of claim 1, wherein the dispenser is configured to receive a container through the opening, engage the container with resting surface, and is secured by the securing mechanism.

10. A dispenser system for a container comprising:
a dispenser body including a first end, second end and a sidewall extending therebetween, the sidewall defining the dispenser body as tubular with a chamber therein;
a pump connected to the first end of the dispenser body;
an opening at the second end, the opening defined by the sidewall, the opening configured to receive the container into the chamber;
a resting surface within the chamber and connected to the sidewall, the resting surface extending from the sidewall into the chamber, the resting surface configured to engage a top portion of the container; and
at least one tab connected to the sidewall at the second end, the tab moveable from a secured position extending into the chamber and a released position removed from the chamber,
wherein the tab in the released position allows upward movement of the container into the chamber and the tab, in the secured position, prevents downward movement of the container.

11. The system of claim 10, further comprising:
a clamp on an exterior of the dispenser body, the clamp configured to actuate the at least tab between a secured position and a released position,
wherein the clamp is configured to force the at least one tab into the chamber in the secured position and in the released position, the clamp places the at least one tab into the released position.

12. The system of claim 10, wherein the at least one tab is a spring-loaded tab.

13. The system of claim 1, wherein the top portion of the container is a rim and the resting surface engages the rim.

14. The system of claim 1, wherein the securing mechanism is configured to abut a bottom of the container.
